(19) United States
(12) Patent Application Publication
(10) Pub. No.: US 2004/0126562 A1
(43) Pub. Date: Jul. 1, 2004

(54) Sheet or hollow cylinder shaped insulating piece

(76) Inventors: Felice Manzo, Arona (IT); Renzo Pasqualato, Bergamo (IT)

Correspondence Address: ROTHWELL, FIGG, ERNST & MANBECK, P.C., 1425 K STREET, N.W., SUITE 800, WASHINGTON, DC, 20005, US

(21) Appl. No.: 10/471,303

(22) PCT Filed: Mar. 23, 2001
(86) PCT No.: PCT/EP01/03329

(51) Int. Cl. B32B 3/26

(52) U.S. Cl. 428/313.5; 428/313.3; 428/72; 428/131

(57) ABSTRACT

The present invention includes an insulating piece formed from a rubber based elastomeric foam having a density of 30 to 120 g/dm³ or between 40 to 80 g/dm³. The foam may be acrylonitrile-butadiene rubber (NBR), ethylene propylene diene monomer (EPDM) rubber, styrene butadiene rubber (SBR), or butyl rubber (IIR). Additionally, separate air channels are provided which extend in the longitudinal direction outside the projections in a uniform distribution over the cross-sectional area of the insulating piece.

The invention relates to an insulating piece in the form of a sheet or a hollow cylinder, having an outer wall and an inner wall from which elastically deformable projections extend.

A heat- and sound-absorbing sleeve in the form of a relatively rigid sheet made of fiber material is known from German Patent 21 18 046 B2 which has an outer side and an inner side. Longitudinal grooves are recessed on the inner side, between which projections are formed.

In a sleeve of similar design for ventilation and air conditioning systems according to German Patent Application 25 08 733 A1, the outer side of the sheet is coated with a sealing film and the inner side having the projections is covered with a protective net.

The elasticity of the known sheets is very limited, particularly in the direction of their thickness.

According to German Patent 24 61 013 B2, a plastic sleeve is extruded onto a metallic core tube to form a composite tube. The plastic sleeve is made of a foamed plastic, the extrusion being performed in such a way that the plastic sleeve has longitudinal channels extending through its surface facing the core tube, the cross section of the longitudinal channels having a shape such that the plastic sleeve is in contact with the core tube only via narrow ribs. The foamed plastic is made of a mixture of low-density polyethylene and high-density polyethylene. Using such a plastic sleeve, insulation of the tube is improved in comparison to a plastic sleeve which is in full contact with the core tube.

According to German Utility Model 94 04 719 U1, half-shells made of plastic are used to encapsulate underground power cables, glass fibers in the form of woven fabric being embedded in the half-shells for reinforcement. Longitudinal bars made of sponge rubber may be glued in as spacers inside the half-shells, making it possible for tubes having a limited range of outer diameters to be received.

European Patent Application 0 744 574 A1 discloses an insulating piece which is formed from two half-shells to be joined along radial surfaces, each half-shell being made of an elastic material and having interior projecting ribs made of an elastic material which in the undeformed state has a minimum receiving space for tubes having a small outer diameter, and in the fully deformed state having a maximum receiving space for tubes having a larger outer diameter. The ribs may be radially disposed, either totally or partially.

The object of the present invention is to design the insulating piece of the aforementioned type in such a way that a high elastic deformability is ensured in the direction of the thickness or in the radial direction, while at the same time the apparent thermal conductivity is further improved.

This object is achieved, based on the insulating piece of the aforementioned type, by the fact that the insulating piece is made of an elastomeric foam based on rubber having a density of 30 to 120 g/dm³, is manufactured in one piece with the projections, and has air channels running essentially parallel in its longitudinal direction.

The thermal conductivity of air at 0° C. is 0.025 W/mK. The thermal conductivity of unfoamed rubber is approximately 0.13 W/mK when the temperature is 0° C. Also at 0° C., the thermal conductivities for foamed rubber range from 0.032 to 0.036 W/mK, which at the temperature of 40° C. specified by the [German] Regulation for Heating Systems means a range of 0.036 to 0.040 W/mK. For insulating materials having these values, the calculated value of the thermal conductivity in accordance with the Regulation for Heating Systems is 0.04 W/mK.

It has been shown that, based on the inventive combination of elastomeric foam with the inner projections and the axial air channels, tubes with various outer diameters within specified limits can be received, and also that the apparent thermal conductivity unexpectedly has values of 0.029 to 0.032 W/mK at 0° C. This means that an improved insulation effect is achieved in comparison to conventional material (the calculated value of the thermal conductivity in accordance with the Regulation for Heating Systems is 0.035 W/mK), or that, in comparison to conventional material having the same insulating effect, the thickness of the insulating piece may be reduced, resulting in a savings in materials and therefore lower costs.

The density of the foam is advantageously between 40 and 80 g/dm³.

In order that essentially no changes in the apparent thermal conductivity occur over the cross-sectional area of the insulating piece, the air channels should be uniformly distributed over the cross-sectional area.

Air channels are preferably situated in the direction of the thickness or in the radial direction of the insulating piece between its projections and its outer wall, so that when the projections are deformed by the receiving of tubes having a large outer diameter the elastic material displacement is partially compensated for by a reduction in the cross-sectional area of the air channels.

It has been found to be advantageous when the portion of the sum of the cross-sectional areas of the air channels relative to the cross-sectional area of the uncompressed insulating piece is 10 to 40%, preferably 20%.

Acrylonitrile-butadiene rubber (NBR), ethylene propylene diene monomer (EPDM) rubber, styrene butadiene rubber (SBR), or butyl rubber (IIR) are advantageously used for the elastic foam.

Exemplary embodiments of the invention are explained in greater detail with reference to the drawings:

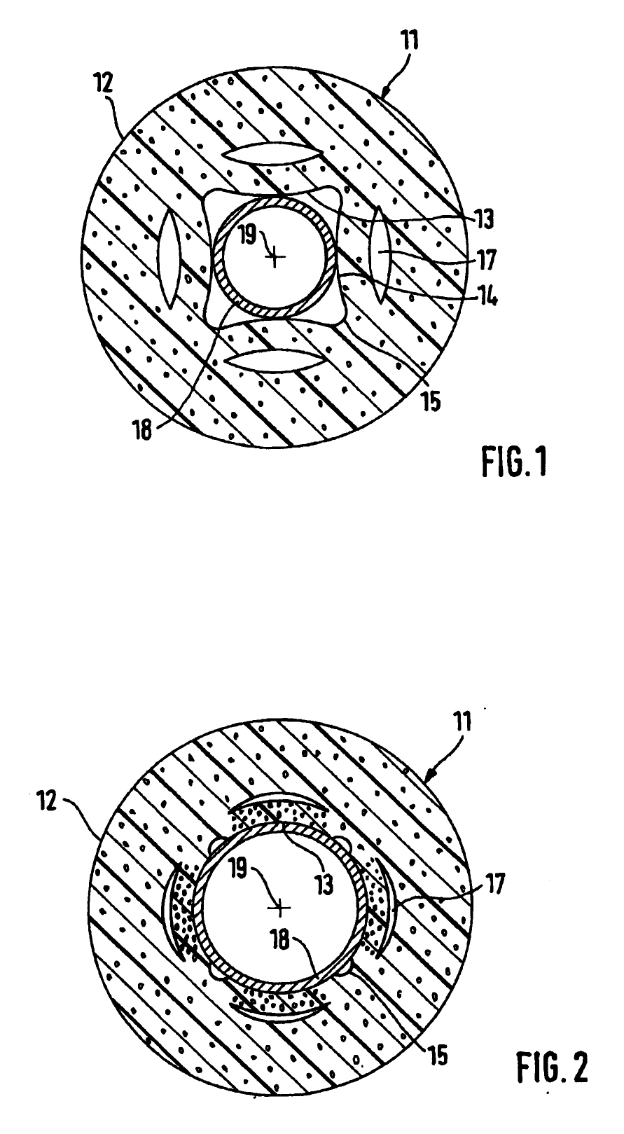

FIG. 1 shows a cross section through a first embodiment of an insulating piece in the form of a hollow cylinder which has a tube of minimum outer diameter;

FIG. 2 shows the embodiment from FIG. 1 which has a tube of maximum outer diameter;

FIG. 3 shows an insulating piece in cross section, modified with respect to FIG. 1, in the form of a hollow cylinder which has a tube of minimum outer diameter;

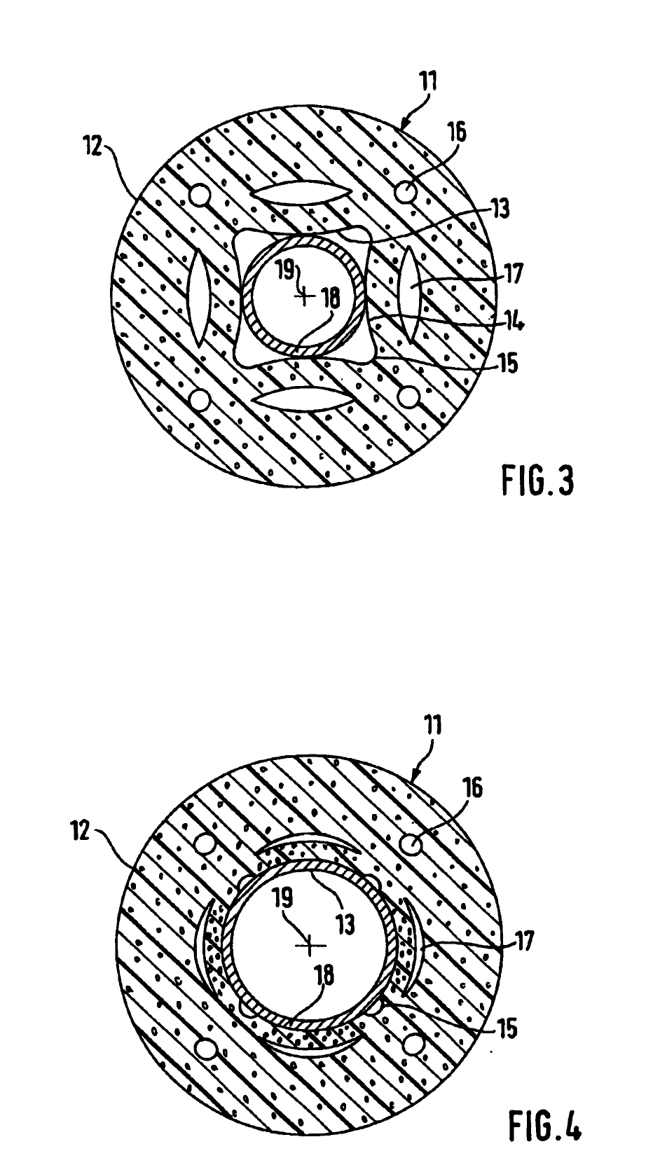

FIG. 4 shows the insulating piece which has a tube of maximum outer diameter, in a view as in FIG. 3;

FIG. 5 shows in cross section a third embodiment of an insulating piece in the form of a hollow cylinder which has a tube of minimum outer diameter;

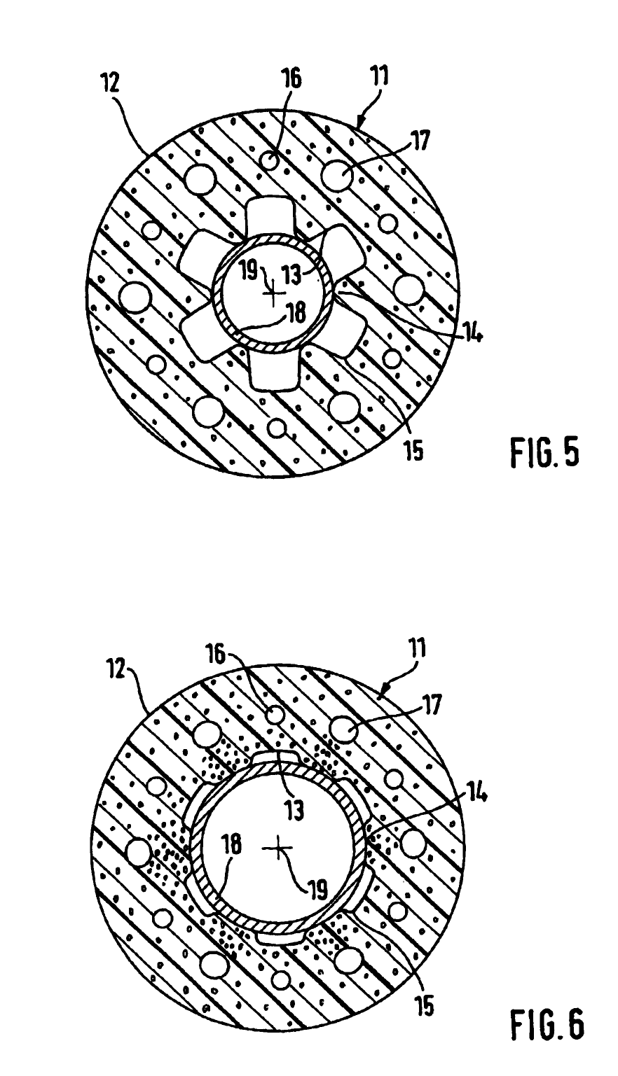

FIG. 6 shows the insulating piece which has a tube of maximum outer diameter, in a view as in FIG. 5;

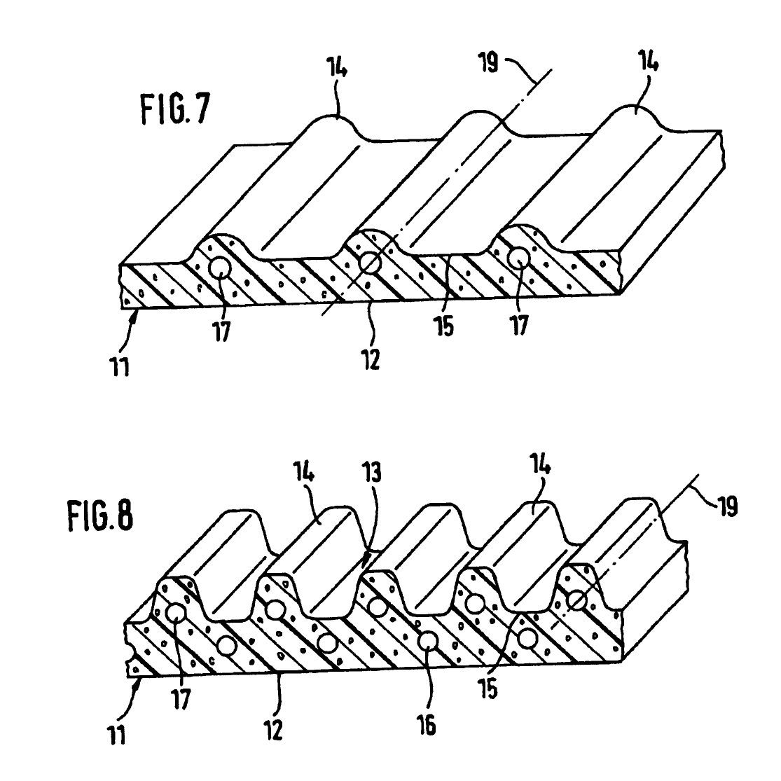

FIG. 7 shows in cross section a fourth embodiment of an insulating piece in the form of an uncompressed sheet; and

FIG. 8 shows a modified uncompressed sheet in a view as in FIG. 7.

Insulating piece 11 shown in FIGS. 1 and 2 comprises a hollow cylinder which has an outer wall 12 and an inner wall 13. Inner wall 13 has four projections 14 separated from one another essentially at 90° which are joined together at rounded corners 15. At a radial distance from each projection 14 an air channel 17 is situated which has an approximately lens-shaped design in the exemplary embodiment shown. Four air channels 17 correspond to the four projections 14. Air channels 17 extend in longitudinal direction 19 of insulating piece 11, and thus essentially parallel to the axis thereof.

According to FIG. 1, a tube 18 is held between the four projections 14 and has an outer diameter dimensioned such that tube 18 is held supported by projections 14 without projections 14 being deformed. Tube 18 shown thus has the minimum outer diameter.

In FIG. 2, a tube 18 which has a maximum outer diameter is inserted between the four projections 14, which elastically deform and cause elastic material to be displaced in the direction of air channels 17, which consequently decrease in volume and assume the shape of a crescent moon. Rounded corners 15, however, remain free, and form air channels parallel to the axis which are bounded by the outer wall of tube 18.

On account of the elastic material properties of the elastomeric foam based on rubber, insulating piece 11 may be used for tubes 18 in the range of the minimum outer diameter shown up to the maximum outer diameter shown. It is extremely simple to fabricate insulating piece 11 by extrusion. Air channels 17 allow projections 14 to be deformed more easily, and also ensure that, together with the foam, the apparent thermal conductivity compared to the pure foam is unexpectedly greatly reduced.

In the embodiments shown in FIGS. 3 and 4, four air channels 16 are provided, in addition to lens-shaped air channels 17, which have a circular cross section when hollow cylinder 11 is uncompressed, and thus when tube 18 having a minimum diameter is received. To ensure a uniform distribution of air channels 17 over the cross section, each additional air channel 16 is situated equidistantly from the corners of lens-shaped air channels 17. FIG. 4 shows the insulating piece from FIG. 3 in the state of receiving the tube having a maximum outer diameter, the circular cross section of air channels 16 being flattened to an ellipse. The volume of air in the elastomeric foam based on rubber is increased by additional air channels 16, thus contributing to a reduction in the thermal conductivity.

In the embodiment shown in FIGS. 5 and 6, the hollow cylinder forming insulating piece 11 has on its inner wall 13 six projections 14 provided in an equidistant arrangement and having large corner regions 15 in between. Six circular air channels 17 provided at a radial distance are associated with the six projections 14. One air channel 16, whose cross section is smaller than that of air channel 17, is associated with each corner 15 at a radial distance.

In FIG. 5, insulating piece 11 receives tube 18 which has a minimum outer diameter and which is held between projections 14.

In FIG. 6, insulating piece 11 receives tube 18 which has a maximum outer diameter. In this state, in the region of corners 15 flat air channels still remain between the foam and the outer wall of the tube. The material displacement of the expanded foam causes the circular shape of air channels 17 associated with projections 14 to become flattened on their side facing projection 14.

Insulating piece 11 shown in FIG. 7 has the form of a sheet made of the same elastomeric foam based on rubber as the hollow cylindrical insulating pieces shown in FIGS. 1 through 6. Insulating piece 11 in the form of a sheet has a flat outer wall 12 and an inner wall 13, situated on the opposite side in the direction of the thickness of the sheet, which is formed from bar-shaped projections 14 rising up therefrom and depressions 15 located in between which are separated at a distance from one another. Projections 14 and depressions 15 extend in the longitudinal direction 19 of the sheet indicated by the dotted-dashed line. Air channels 17 are provided between projections 14 and outer wall 12 in the direction of the thickness, and extend in longitudinal direction 19 in sheet 11.

Whereas in the embodiment shown in FIG. 7 projections 14 have a continuously arched design, in the embodiment shown in. FIG. 8 the projections run with a tooth-like cross section. Additional air channels 16 are provided in the direction of the thickness, between depressions 15 and outer wall 12.

Insulating pieces 11 in the form of sheets, as illustrated by way of example in FIGS. 7 and 8, are wrapped around curved objects to be insulated and may be subjected to a different contact pressure, causing projections 14 to become smaller by pressing together, and at higher contact pressures air channels 17 also deform, and subsequently air channels 16 correspondingly deform as well.

The design of the insulating piece with respect to the number and shape of the projections and air channels is not limited, but the uniform distribution of the air channels in the expanded foam over the cross-sectional area of the insulating piece, as well as their cross-sectional portion, which is preferably 20% relative to the cross-sectional area of the insulating piece, are important.

1. Insulating piece (11) in the form of a sheet or a hollow cylinder, having an outer wall (12) and an inner wall (13) from which elastically deformable projections (14) extend, characterized in that the insulating piece (11)
is made of an elastomeric foam based on rubber having a density of 30 to 120 g/dm³,
is manufactured in one piece with the projections (14), and
has air channels (16, 17) running essentially parallel in its longitudinal direction (19).

2. Insulating piece according to claim 1, characterized in that the density of the foam is 40 to 80 g/dm³.

3. Insulating piece according to claim 1 or 2, characterized in that the air channels (16, 17) are uniformly distributed over the cross-sectional area of the insulating piece (11).

4. Insulating piece according to one of the preceding claims, characterized in that air channels (17) are situated between the projections (14) and the outer wall (12) in the direction of the thickness of the sheet or in the radial direction of the hollow cylinder.

5. Insulating piece according to one of the preceding claims, characterized in that the portion of the sum of the cross-sectional areas of the air channels relative to the cross-sectional area of the uncompressed insulating piece (11) is 10 to 40%.

6. Insulating piece according to one of the preceding claims, characterized in that the elastomeric foam is made of acrylonitrile-butadiene rubber (NBR), ethylene propylene diene monomer (EPDM) rubber, styrene butadiene rubber (SBR), or butyl rubber (IIR).
